(19) United States
(12) Patent Application Publication
(10) Pub. No.: US 2025/0144906 A1
(43) Pub. Date: May 8, 2025

(54) ROLLER ARRANGEMENT AND METHOD

(71) Applicant: Vestel Elektronik Sanayi ve Ticaret A.S., Manisa (TR)

(72) Inventors: Mustafa Serkan AKOGLU, Manisa (TR); Özgür KAYRAN, Manisa (TR); Ozan YILMAZ, Manisa (TR); Ali MACIT, Manisa (TR)

(21) Appl. No.: 18/837,403

(22) PCT Filed: Feb. 10, 2022
(86) PCT No.: PCT/EP2022/053228

§ 371 Date: Aug. 9, 2024

(51) Int. Cl. B30B 15/28; B30B 3/00; B30B 9/00; B30B 15/00

(52) U.S. Cl. CPC B30B 15/28; B30B 3/005; B30B 15/0023; B30B 9/00

(57) ABSTRACT

A roller arrangement is provided for a machine for applying a force to a display screen during assembly of the display screen to a frame. The roller arrangement has a first plate, for connecting the roller arrangement to a robot assembly, and a second plate. A roller is supported by the second plate. The roller can rotate and apply a force to a display screen during assembly of the display screen to a frame. At least one resilient member is arranged between the first plate and the second plate to connect the first plate and the second plate to each other such that the first plate and the second plate are spaced from each other. The resilient member can absorb a shock or excessive force applied to at least one of the first plate and the second plate.

### TECHNICAL FIELD

The present disclosure relates to a roller arrangement for a machine for and a method of applying a force to a display screen during assembly.

### BACKGROUND

Display screens, for display devices such as computer screens, television sets, etc., have previously been mounted in and supported by a backing frame. The backing frame typically partially surrounded the edges at the front of the display screen in order to provide support and to maintain the screen in place. This results in a large “bezel” (i.e. the grooved edges of the frame) at the edges of the display device. More recently, so-called “bezel-less” or “borderless” display devices have become available. In a borderless display device there is no bezel or only a very narrow bezel. However, problems arise when assembling the display screen to the backing frame in a borderless display device.

### SUMMARY

According to a first aspect disclosed herein, there is provided a roller arrangement for a machine for applying a force to a display screen during assembly of the display screen to a frame, the roller arrangement comprising:
a first plate arranged to enable the roller arrangement to be connected to a robot assembly for manipulating the roller arrangement in use;
a second plate;
at least one roller which is supported by the second plate, the roller being arranged to rotate in use about a roller axis and to apply a force to a display screen during assembly of the display screen to a frame; and
at least one resilient member arranged between the first plate and the second plate to connect the first plate and the second plate to each other such that the first plate and the second plate are spaced from each other, whereby the resilient member can absorb a shock or excessive force applied to at least one of the first plate and the second plate.

The one or more resilient members absorb shock or excessive force, typically by compression as the first and second plate move towards each other when a force is applied by the roller to the display screen during assembly of the display screen to a frame. This prevents shock or excessive force being applied by the roller to the display screen as the roller is rolled across the display screen during assembly of the display screen to a frame.

In use, typically the roller axis of the roller will be horizontal as in practice the display screen and frame are typically laid out horizontally when the display screen is being attached to the frame. The roller can then be moved across one or more edges of the horizontal display screen to press the edges of the display screen to the frame. Typically, the first plate will be an upper plate which is uppermost in use and the second plate will be a lower plate which is lowermost in use.

In an example, the roller arrangement comprises a rotary actuator for rotating the roller about a rotation axis.

In use, typically the rotation axis of the rotary actuator is vertical. This enables the roller to be rotated about a vertical axis. In turn, this means that the roller can roll first along one edge of a horizontally arranged display screen, be rotated through 90°, and then roll along a second, perpendicular, edge of the display screen. All the time, the one or more resilient members absorb shock as the roller is moved up and down and along the edges of the display screen.

In an example, the rotary actuator is fixed to the first plate for rotating the first plate, second plate and roller as a unit about a rotation axis.

In use, one part of the rotary actuator is fixed to the first plate and another part of the rotary actuator is connected to a robot assembly which manipulates the roller arrangement in use.

In an example, the roller arrangement comprises a load cell, the roller being connected to the second plate via the load cell such that the load cell provides a measure of a force being applied in use by the roller to a display screen as the roller is moved across the display screen.

The measure of the force being applied by the roller can be provided in use by the load cell to a controller of the robot assembly which controls the movement of the roller arrangement accordingly.

There may also be provided a machine for applying a force to a display screen during assembly of the display screen to a frame, the machine comprising:
a roller arrangement as described above, and
a robot assembly for controllably moving the roller arrangement in three mutually perpendicular directions.

According to a second aspect disclosed herein, there is provided a method of applying a force to a display screen during assembly of the display screen to a backing frame, the method comprising:
controlling a roller arrangement, the roller arrangement comprising a first plate which is connected to a robot assembly for manipulating the roller arrangement; a second plate; at least one roller which is supported by the second plate, the roller being arranged to rotate in use about a roller axis; and, at least one resilient member arranged between the first plate and the second plate to connect the first plate and the second plate to each other such that the first plate and the second plate are spaced from each other, whereby the resilient member can absorb a shock or excessive force applied to at least one of the first plate and the second plate;
the controlling the roller arrangement comprising:
positioning the roller over the edge of a display screen which is laid on a backing frame;
bringing the roller into contact with the edge of the display screen; and
moving the roller arrangement along the edge of the display screen to cause the roller to apply a force to the edge of the display screen during assembly of the display screen to the backing frame.

In an example, the method comprises rotating the roller arrangement through 90° about a vertical axis when the roller has reached the end of an edge of the display screen, and moving the roller arrangement along a second edge of the display screen which is perpendicular to the first edge of the display screen.

### BRIEF DESCRIPTION OF THE DRAWINGS

To assist understanding of the present disclosure and to show how embodiments may be put into effect, reference is made by way of example to the accompanying drawings in which:

FIG. 1 shows schematically an elevation from one side of an example of a machine for applying a force to a display screen, the machine having an example of a roller arrangement according to an embodiment of the present disclosure;

FIG. 2 shows schematically an elevation from one end of the machine of FIG. 1;

FIG. 3 shows schematically a plan view from above of the machine of FIG. 1; and

FIG. 4 shows schematically a side elevation of the example of a roller arrangement according to an embodiment of the present disclosure.

### DETAILED DESCRIPTION

Display devices are used in many different types of consumer apparatus including for example television screens or monitors, computer displays or monitors, and displays for other computing devices, including smartphones, tablet computers, laptop computers, etc. Display devices are also used in many public environments in so-called “signage”, for example, for displaying advertisements or for information or entertainment that is of interest to a larger audience.

As mentioned, display screens for display devices have previously been mounted in and supported by a backing frame. The backing frame typically partially surrounded the edges at the front of the display screen in order to provide support and to maintain the screen in place. This results in a large “bezel” (i.e. the grooved edges of the frame which receive the edges of the display screen) at the edges of the display device.

More recently, so-called “bezel-less” or “borderless” display devices have become available. In a borderless display device there is no bezel or border at the edge of the display screen, or only a very narrow border. For example, the border may only have a width that is less than 1% of the width of the display screen, and in some cases there may be no bezel at all beyond the edges of the display screen.

However, problems arise when assembling the display screen to the backing frame in a borderless display device. In particular, in a traditional display device, the backing frame provides a bezel, that is, a border having grooves or recesses in which the respective edges of the display screen are received. In a borderless display device, there is no such bezel having grooves for the edges of the display screen. Therefore, when assembling the display screen to the backing frame in a borderless display device, the display screen is typically fastened to the backing frame by an adhesive, which may for example be in the form of double-sided adhesive tape. The tape or other adhesive is fixed to the edges of the frame. During assembly of the display device, the frame is typically arranged to lie in a horizonal plane. The display screen is then laid on top of the backing frame. A force is then applied to the edges of the display screen to cause the edges of the display screen to adhere to the adhesive on the edges of the frame, thereby fixing the display screen to the frame. Such force is typically applied manually by human operators using a hand-held roller or by a robot which uses pneumatic cylinders as force applicators.

Applying the force manually can cause quality problems because of the practical inability for the human operator to precisely control the amount of force that is applied. It is also ergonomically harmful for the human operator to apply forces like this manually, especially for large display screens as the screen is wide compared to the average reach of a human arm.

A problem with using robots with pneumatic cylinders to apply the force is that applying the correct desired force depends on the stability of pressure of the air input to the pneumatic cylinders. If there is a fluctuation in the pressure of the air input, more or less force will be applied than desired. This can result in irreparable damage to the display screen or cause the display screen to not adhere properly to the backing frame.

In either case, excessive force or shocks can inadvertently be applied to the display screen during the application of the pressure force, which can result in irreparable damage to the display screen during assembly.

In overview, examples described herein provide a roller arrangement for a machine for applying a force to a display screen during assembly of the display screen to a frame. The roller arrangement has a first plate and a second plate. The first plate enables the roller arrangement to be connected to a robot assembly for manipulating the roller arrangement in use. The roller arrangement has at least one roller which is supported by the second plate. The roller is arranged to rotate in use about a roller axis and to apply a force to a display screen during assembly of the display screen to a frame. At least one resilient member is arranged between the first plate and the second plate to connect the first plate and the second plate to each other such that the first plate and the second plate are spaced from each other. The resilient member can absorb a shock or excessive force applied to at least one of the first plate and the second plate in use.

The one or more resilient members absorb shock or excessive force, typically by compression as the first and second plate move towards each other when a force is applied by the roller to the display screen during assembly of the display screen to a frame. This prevents shock or excessive force being applied by the roller to the display screen as the roller is rolled across the display screen during assembly of the display screen to a frame.

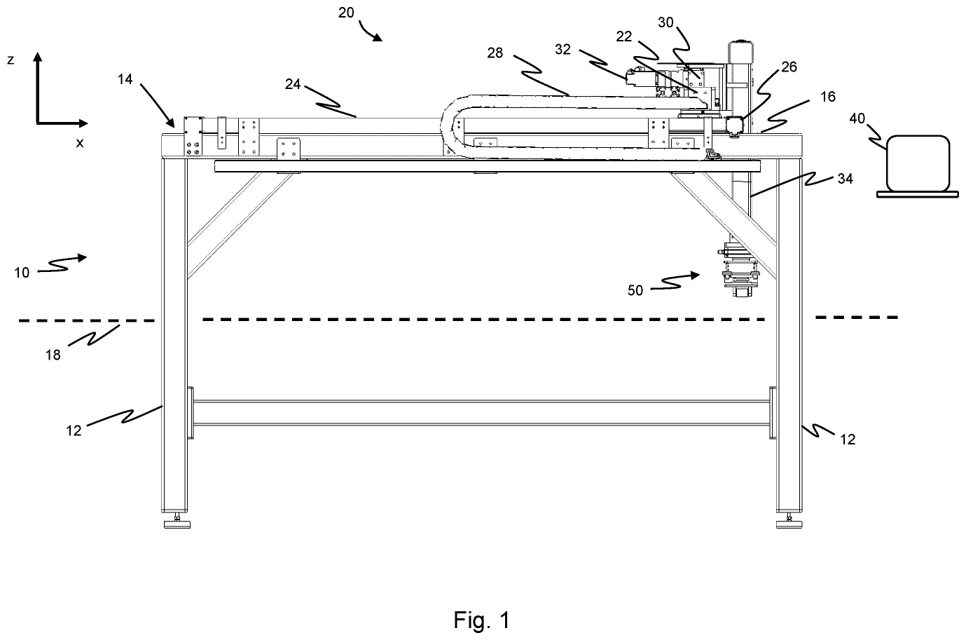

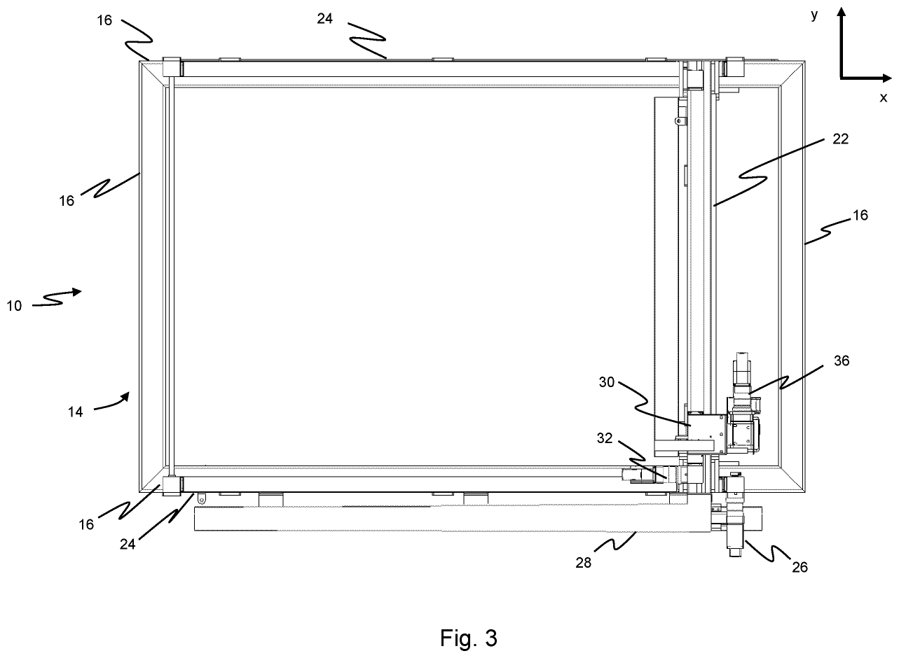

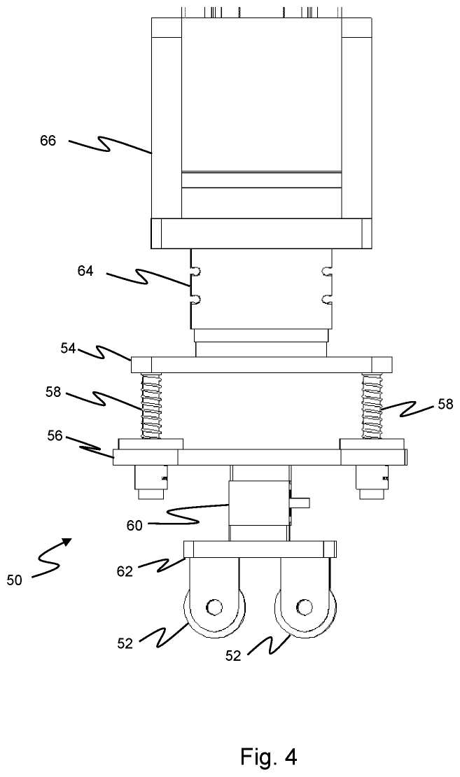

Referring now to the drawings, FIGS. 1 to 3 show respectively a side view, end view and plan view of an example of a machine 10 for applying a force to a display screen, and FIG. 4 shows a side view of an example of a roller arrangement 50 according to an embodiment of the present disclosure which may be used in the example machine 10 of FIGS. 1 to 3. The machine 10 provides a support for a robot assembly which manipulates the roller arrangement 50 in use, as will be discussed. The robot assembly is a 3-axis robot, again as will be discussed.

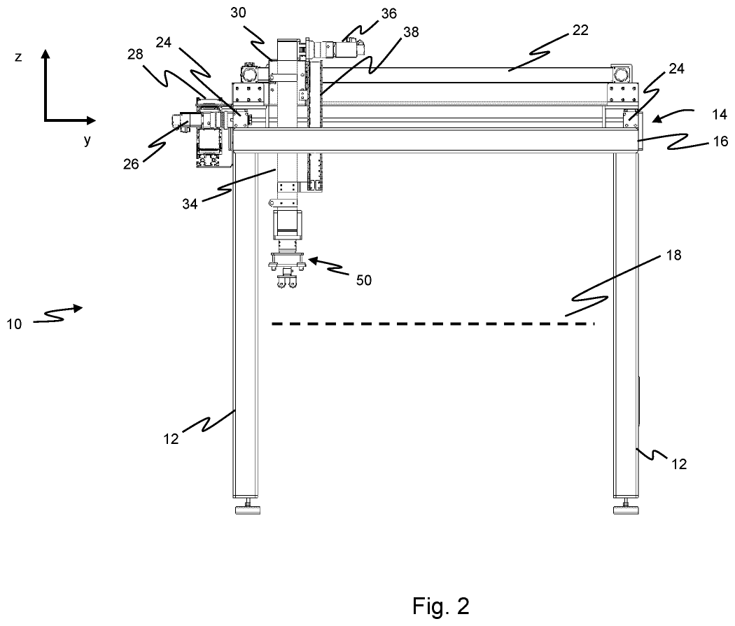

The machine 10 has a generally open, frame-like structure. In particular, the machine 10 has four vertical legs 12 which support an upper rectangular frame 14. In this example, the upper rectangular frame 14 is formed of two side and two end members 16. In use, the machine 10 is located over a table or conveyor 18 (shown schematically as a dashed line in FIGS. 1 and 2) on which backing frames for display devices are located. The legs 12 straddle the table or conveyor 18 and the upper rectangular frame 14 is located above the table or conveyor 18.

The machine 10 has a robot assembly 20 to which the roller arrangement 50 is connected. The robot assembly 20 of this example enables the roller arrangement 50 to be moved in three perpendicular directions, shown as x and y for the horizontal plane and z for the vertical axis in the drawings.

For this, first, the robot assembly 20 has a cross-bar 22 which extends in the y direction across the upper rectangular frame 14. The cross-bar 22 can move back and forth in the x direction, that is, parallel to the long side members 16 of the upper rectangular frame 14. For this, in this example, the opposed ends of the cross-bar 22 fit in or move over respective runners 24 which are provided along the long side members 16 of the upper rectangular frame 14. The runners 24 may have grooves or recesses for receiving the respective ends of the cross-bar 22. Wheels or sliders, etc., may be provided on the runners 24 and/or the ends of the cross-bar 22 to facilitate the movement. Movement of the cross-bar 22 in this example is driven by an electric motor 26 via a drive belt or chain 28. Other arrangements for enabling the movement of the cross-bar 22 in the x direction are possible.

Secondly, for movement back and forth in the y direction, the roller arrangement 50 is connected to a carrier 30 which itself is connected to the cross-bar 22 so as to be able to move back and forth along the cross-bar 22 (i.e. in the y direction). The carrier 30 may have wheels or sliders or the like to facilitate movement along the cross-bar 22. Movement of the carrier 30 back and forth along the cross-bar 22 in this example is driven by a second electric motor 32.

Thirdly, for movement up and down in the z direction, the roller arrangement 50 is mounted on a vertical post 34 which itself is connected to the carrier 30 so as to be able to move up and down relative to the carrier 30. Movement of the vertical post 34 up and down in this example is driven by a third electric motor 36 via a drive belt or chain 38.

Other arrangements for enabling the movement of the roller arrangement 50 in one or more of the x direction, y direction and z direction are possible, as will be well understood by those skilled in industrial robots and the like.

Referring now also to FIG. 4, the roller arrangement 50 has at least one roller 52. In this example, the roller arrangement 50 has two rollers 52, but more or fewer rollers 52 may be provided in other examples. The or each roller 52 rotates about a respective roller axis, which in a typical arrangement is horizontal.

In use, when assembling a display device in which a display screen is being assembled to a backing frame, particularly when assembling a borderless display device, a backing frame is placed on the horizontal table or conveyor 18 and adhesive is applied to one or more edges of the backing frame. The adhesive is commonly in the form of double-sided adhesive tape in practice. The adhesive is typically applied to three edges of the backing frame, the fourth edge being where control inputs and the like for the display device are provided. The display screen is then laid over and placed on the backing frame. The roller arrangement 50 is then located generally over the backing frame and display screen, for example by pushing the table or driving the conveyor, on which the backing frame and display screen are located, into position. The roller arrangement 50 is then operated to bring the roller(s) 52 into contact with the edges of the display screen in turn. The roller arrangement 50 is operated to apply a force to the edges of the display screen in turn, which causes the edges of the display screen to adhere to the adhesive on the edges of the frame, thereby fixing the display screen to the frame.

To bring the roller(s) 52 into contact with the display screen, first the roller arrangement 50 is driven in the x and/or y directions (i.e. in the horizontal plane) by operation of the first and second electric motors 26, 32 as necessary to locate the roller arrangement 50 over an edge and more preferably over a corner of the display screen. Movement of the roller arrangement 50 and therefore the driving of the first and second electric motors 26, 32 may be carried out under control of a controller 40 which controls the machine 10 and robot assembly 20 generally. The controller 40 may be one or more processors which are integrated with the machine or, as illustrated, may be provided by a separate computing device which is in communication with the machine 10. The controller 40 may receive inputs from one or more sensors which provide outputs indicative of the location of the roller arrangement 50. Alternatively or additionally, the coordinates of the edges and corners of the display screen relative to the machine 10 may be input to the controller 40, for example by a human operator based on the size and location of the display screen, and the controller 40 drives the first and second electric motors 26, 32 as necessary. In general, the control of the first and second electric motors 26, 32, and of the third electric motor 36, may be servo control.

Once the roller arrangement 50 is located over an edge or a corner of the display screen, the third electric motor 36 is operated to drive the roller arrangement 50 downwards in the z direction, to bring the roller(s) 52 into contact with the display screen and apply a force to the display screen. Then, whilst the roller(s) 52 are in contact with the display screen, the roller arrangement 50 is moved along the edge of the display screen by appropriate driving of the first and second electric motors 26, 32 as the cases may be. This presses the display screen against the adhesive on the backing frame to fix the display screen to the backing frame.

A particular problem that can occur is that the rollers 52 are brought into contact with the display screen too quickly or with too high a force, such that a shock or excessive force is applied to the display screen. This can damage the display screen.

To prevent this, the roller arrangement is formed of a first plate 54 and a second plate 56 which are connected to each other and spaced from each other by one or more resilient members 58. The first plate 54 provides a connection for the roller arrangement 50 to be connected to the robot assembly 20. A particular example arrangement for this will be discussed further below. The second plate 56 provides a support for the roller(s) 52. Again, a particular example arrangement for this will be discussed further below. The first and second plates 54, 56 may be formed of a rigid material, such as a rigid plastics or metal material.

The or each resilient member 58 may be a compression spring, such as for example a coil spring. Other arrangements are possible, such as leaf springs, elastomeric dampers, etc. In the example shown, there are four resilient members 58, which are located at respective corners of the generally square first and second plates 54, 56. The resilient members 58 act as shock absorbers to absorb shock or excessive force which may occur when the rollers 52 are brought into contact with the display screen or when the rollers 52 are moved across the display screen. The resilient members 58 therefore enable the force that is applied to the display screen to be increased, or decreased, smoothly at the point of contact of the rollers 52 with the display screen. The resilient members 58 may have a damping mechanism, such as oil dampers or some other damping arrangement, which helps prevent the resilient members 58 recoiling or bouncing if a shock or excessive force occurs.

The force that is applied by the roller(s) 52 to the display screen may be set by a human operator providing an input for the desired force to the controller 40. The controller 40 then drives the third electric motor 36 to press the roller(s) 52 into contact with the display screen with the desired force. The third electric motor 36 may be operated so that the initial movement of the roller arrangement 50 and therefore the rollers 52 downwards is relatively fast until the rollers 52 come into contact with the display screen. Then, once the rollers 52 have come into contact with the display screen, the roller arrangement 50 and therefore the rollers 52 are moved downwards at a much lower speed until the desired force is applied to the display screen.

To facilitate the control of the vertical movement of the roller arrangement 50 to press the rollers 52 against the display screen with the desired force, in this example the rollers 52 are connected to the body of the roller arrangement 50 via a load cell 60. A load cell is a force transducer which converts a force into an electrical signal. In the example shown, the or each roller 52 is mounted to a third plate 62 which connects to one side of the load cell 60. The opposed side of the load cell 60 is connected to the lower surface of the second plate 56. The output of the load cell 60 is provided to the controller 40 to provide control of the third electric motor 36, in turn to control movement of the roller arrangement 50 in the z (vertical) direction appropriately so that the correct desired amount of force is applied by the rollers 52 to the display screen to fix the display screen to the backing frame. The rollers 52 may be raised or lowered as necessary so that the correct desired force is applied to the display screen. This feedback from the load cell 60 to the controller 40 may be used continually as the rollers 52 are moved along the edges of the display screen, so that the correct desired force is applied at all times. This allows for small differences in height, material rigidity and mechanical imperfections which can arise in practice owing to normal manufacturing tolerances. The load cell 60 may be for example a so-called S-type load cell.

Once the rollers 52 have been rolled along one edge of the display screen, it is desirable to be able to reorientate the rollers 52 relative to the display screen so as to be able to roll along an adjacent edge of the display screen, which is perpendicular to the first edge. In the example shown, this is achieved by the roller arrangement 50 having a rotary actuator 64. In the example shown, the rotary actuator 64 is fixed on one side to the upper surface of the first plate 54, which is opposite the second plate 56, and on the other side to a mount 66 which fixes to the vertical post 34 of the robot assembly 20. The rotary actuator 64 may be driven by an electric motor, a pneumatic line, etc, under control of the controller 40 of the robot assembly 20. The rotary actuator 64 is vertically arranged in this example. Once the rollers 52 have been rolled along the length of an edge of the display screen to fix the display screen to the backing frame, and preferably once the rollers 52 have reached a corner of the display screen, the rotary actuator 64 is operated to rotate the first plate 54 and therefore the second plate 56 and the rollers 52 through 90° about a vertical axis. The robot assembly 20 is then operated to drive the rollers 52 along the next edge. This is then repeated as necessary for one or both of the remaining edges of the displays screen.

It is noted that the use of an electric motor 36 to drive the vertical movement of the roller arrangement 50 is preferred over the use of pneumatic cylinders which are used in some known systems because a pneumatic arrangement cannot respond to changes in height as the roller arrangement 50 is moved over the display screen and therefore it is impossible to adjust the applied force. This can result in damage to the display screen. The use of an electric motor 36 to drive the vertical movement of the roller arrangement 50, and indeed use of electric motors 26, 32 to drive the horizontal movement of the roller arrangement 50, allows for faster as well as more accurate movement of the roller arrangement 50 and therefore assembly of the display device. Separately, both manual systems, where the display screen is pressed manually by a human operator, and known pneumatic systems provide no effective feedback mechanism to allow the applied force to be measured and properly controlled. The use of the load cell 60 to provide to the controller 40 a feedback signal which is indicative of the strength of the applied force ensures that the controller 40 drives the third electric motor 36 to apply the correct, desired force to the display screen during fixing to the backing frame.

Further, the use of electric motors 26, 32 to drive the horizontal movement of the roller arrangement 50 and an electric motor 36 to drive the vertical movement of the roller arrangement 50, together with the load cell 60 and the rotary actuator 64 together enable the whole assembly process to be automated. This enables the assembly of the display screen to the backing frame to be carried quickly and accurately, with a low risk of damage being caused to the display screen, and also avoids human operators having to carry out potentially harmful steps manually.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A roller arrangement for a machine for applying a force to a display screen during assembly of the display screen to a frame, the roller arrangement comprising:
a first plate arranged to enable the roller arrangement to be connected to a robot assembly for manipulating the roller arrangement in use;
a second plate;
at least one roller which is supported by the second plate, the roller being arranged to rotate in use about a roller axis and to apply a force to a display screen during assembly of the display screen to a frame; and
at least one resilient member arranged between the first plate and the second plate to connect the first plate and the second plate to each other such that the first plate and the second plate are spaced from each other, whereby the resilient member can absorb a shock or excessive force applied to at least one of the first plate and the second plate.

2. A roller arrangement according to claim 1, comprising a rotary actuator for rotating the roller about a rotation axis.

3. A roller arrangement according to claim 2, wherein the rotary actuator is fixed to the first plate for rotating the first plate, second plate and roller as a unit about a rotation axis.

4. A roller arrangement according to claim 1, comprising a load cell, the roller being connected to the second plate via the load cell such that the load cell provides a measure of a force being applied in use by the roller to a display screen as the roller is moved across the display screen.

5. A machine for applying a force to a display screen during assembly of the display screen to a frame, the machine comprising:
a roller arrangement according to claim 1, and
a robot assembly for controllably moving the roller arrangement in three mutually perpendicular directions.

6. A method of applying a force to a display screen during assembly of the display screen to a backing frame, the method comprising:
controlling a roller arrangement, the roller arrangement comprising a first plate which is connected to a robot assembly for manipulating the roller arrangement; a second plate; at least one roller which is supported by the second plate, the roller being arranged to rotate in use about a roller axis; and, at least one resilient member arranged between the first plate and the second plate to connect the first plate and the second plate to each other such that the first plate and the second plate are spaced from each other, whereby the resilient member can absorb a shock or excessive force applied to at least one of the first plate and the second plate;
the controlling the roller arrangement comprising:
positioning the roller over the edge of a display screen which is laid on a backing frame;
bringing the roller into contact with the edge of the display screen; and
moving the roller arrangement along the edge of the display screen to cause the roller to apply a force to the edge of the display screen during assembly of the display screen to the backing frame.

7. A method according to claim 6, comprising rotating the roller arrangement through 90° about a vertical axis when the roller has reached the end of an edge of the display screen, and moving the roller arrangement along a second edge of the display screen which is perpendicular to the first edge of the display screen.
